(19) United States
(12) Patent Application Publication
(10) Pub. No.: US 2024/0351404 A1
(43) Pub. Date: Oct. 24, 2024

(54) WINDOW ASSEMBLY FOR HEAVY DUTY OFF-HIGHWAY EQUIPMENT, METHOD OF USE, METHOD OF INSTALLATION, AND OFF-HIGHWAY EQUIPMENT USING SAME

(71) Applicant: Bodygard LLC, Shinnston, WV (US)

(72) Inventor: Seven SOUTHERN, Shinnston, WV (US)

(21) Appl. No.: 18/640,511

(22) Filed: Apr. 19, 2024

Related U.S. Application Data
(60) Provisional application No. 63/538,896, filed on Sep. 18, 2023.
(60) Provisional application No. 63/460,417, filed on Apr. 19, 2023.

(51) Int. Cl. B60J 1/00; B60J 1/08; B60J 1/20; E02F 3/76; E02F 9/16

(52) U.S. Cl. CPC B60J 1/006; B60J 1/08; B60J 1/2094; E02F 3/76; E02F 9/163

(57) ABSTRACT

A window assembly is provided and designed for use in off-highway equipment designed for material handling, particularly coal handling, wherein the off-highway equipment has a cab with a cab frame and windows. The window assembly includes a frame, a window pane, an adhesive to attach the frame and window pane together and a fastening assembly to attach the metal frame to the cab frame. The frame has an outer peripheral attachment portion that allows the frame to directly attach to the cab frame such that the window pane is not in direct contact with the cab frame and not susceptible to cracking as a result of vibration and flexing of the cab frame during equipment operation.

### FIELD OF THE INVENTION

The invention relates to a window assembly that is designed to be used in heavy duty off-highway material handling equipment, and, in particular, to a window assembly that includes a high strength acrylic window that is mounted to a metal frame, the metal frame including means to allow the metal frame to be mounted to the off-highway material handling equipment.

### BACKGROUND ART

In the coal industry, it is common to use heavy duty material handling off-highway equipment in various aspects of the coal mining operation.

As part of a mining operation, it is often the case that large coal piles are created, with conveyors running under the piles for coal transport. One danger that these coal piles create is the formation or cavities or “honeycombs” in the piles. These cavities/honeycombs can collapse and can cause injury or even death to any workers that may be caught in such a collapse.

Further yet, collapses have occurred in the past wherein off-highway material handling equipment, e.g., bulldozers, were involved in the collapse. When such equipment would be part of the collapse, the prior art windows in the cab were not designed to withstand the pressure created by material collapsed onto the windows. Thus, the windows would fail and, as a result of the coal entering the cab, the operator would be trapped in the cab and could suffocate.

To remedy this problem with off-highway equipment like bulldozers, cabs were built with high strength (40 psi material) windows, which were chemically hardened, such windows developed by Pittsburgh Plate and Glass Company. These kinds of windows were mounted directly to the cab of the bulldozer.

In order to determine whether the use of such windows could isolate an operator if a bulldozer was involved in a coal pile collapse, testing was performed on a bulldozer having a manikin in the cab. The bulldozer was covered in 60 tons of coal, rock, and other debris. Despite the overwhelming forces placed on the cab of the bulldozer, the windows held and the manikin was untouched by the material dumped on the bulldozer.

Despite the successful use of these kinds of high strength windows, a need developed to use even higher strength glass. As a result of this need, a polycarbonate glass was developed as an alternative to the 40 psi windows noted above. This kind of polycarbonate glass was rated at 13000 psi. The glass was cut to shape and directly attached to the cab by drilling with metal self-tapping screws. One problem with this kind of glass was that the surface of the polycarbonate glass tended to scratch due to its softness. This problem was accentuated in the windows that were subject to cleaning/water removal due to the use of wiper blades as the blades tended to substantially scratch the surface of the polycarbonate glass.

As a result of this scratching, a 4 mm film was applied to the surface of any of the windows on the cab that would come into contact with a wiper blade, which were the typically the front, back, and side windows of the cab.

While the use of the film alleviated the scratching problem, other problems developed, including the fact that it was difficult to replace, if need be, and it was especially difficult to replace if the film was left too long on the glass. Films left on the windows for a long period of time also had a tendency to create visual problems for the operator. In some instance, the film could not be easily removed and the entire window had to be replaced, thus creating a cost problem in terms of window replacement and lost productivity due to the equipment being unusable until the repairs were completed.

To solve the film problem, a transparent acrylic material was developed that had almost 20 times the strength of the 40 psi glass originally used as noted above, e.g., 9,000-10,000 psi for the acrylic material. The transparent acrylic material maintained the high strength necessary for the cab window and did not have the scratching problem that the polycarbonate glass had. So, the need for the use of the film was eliminated. While the acrylic material is not as strong as the polycarbonate glass, it still had sufficient strength to protect an operator in the cab. Moreover, it meets the law passed in West Virginia that required safety windows on all equipment that is working coal surge piles. The minimum window strength for this law was 40 psi and the acrylic material was in compliance with the West Virginia law.

In terms of installation, the acrylic material, which was approximately the same thickness as the polycarbonate glass, i.e., 1¼ inches, was attached to the cab in the same way as the polycarbonate glass. That is, holes were drilled through the acrylic material so that the appropriate fasteners could be used to mount the acrylic material directly to the cab.

However, because the acrylic material windows are subject to extreme amounts of vibration and the cab structure is made from a relatively thin gauge material that allows for a lot of flexing during operation of the equipment, the acrylic windows tended to crack at the hole locations and/or exhibit cracking hole to hole. This cracking then necessitated window replacement. With supply chain problems, delivery times for the windows could be months and months. Without the ability to repair the equipment quickly, the equipment was unusable and the idle time for the equipment became costly for the mining operation.

In light of the cracking problem with the film-less acrylic material windows, a need developed for an improved window for this off-highway material handling equipment. The present invention responds to this need by providing an improved window design for the cab of off-highway material handling equipment that is of sufficient high strength but does not experience the cracking problem of the prior art windows due to the excessive vibration of the equipment and bending associated with the off-highway equipment cab.

### SUMMARY OF THE INVENTION

The invention relates to a window assembly that is designed for use in off-highway material handling equipment, particularly coal handing equipment. The window assembly provides a number of benefits in terms of ease of replacement, avoidance of the cracking prevalent in prior art windows for this type of equipment, and maintaining the safety factor that these windows are intended to provide.

One embodiment of the invention is a window assembly for use in off-highway material handling equipment designed for material handling, the off-highway material handling equipment having a cab with a cab frame and windows. The window assembly includes a metal frame having an opening therein and an outer peripheral attachment portion and a window pane made from a polymeric material having first and second surfaces and an outer peripheral face, the first surface having an outer peripheral portion.

A first means for attaching the outer peripheral portion of the first surface of the window pane to a portion of the metal frame is provided so as to leave the outer peripheral attachment portion of the frame exposed. Also provided is a second means for attaching the outer peripheral attachment portion of the frame to a cab frame, the second attaching means independent of the window pane so that the window pane does not develop cracks by direct attachment of the window pane to the cab frame.

While the polymeric material can be many types, an acrylic material is preferred due to its hardness and strength.

The first attaching means can include an adhesive positioned between a surface of the frame adjacent to the outer peripheral attachment portion of the frame and the outer peripheral portion of the window pane.

The second attaching means can include a bracket configured to contact the outer peripheral attachment portion of the frame and having an opening therethrough, at least one through hole in the outer peripheral attachment portion of the frame, and at least one fastener adapted to retain the bracket and the outer peripheral attachment portion of the frame to the cab frame by extending through both the opening in the bracket and the through hole in the outer peripheral attachment portion.

Another embodiment of the invention relates to an improved way to make the frame of the window assembly. While the frame can be plate-like in shape, it can also be made using a bar member that has a t-shape in transverse cross section and connecting the bar members together to form the frame shape for holding the window pane. In this embodiment, the frame would include a base with a leg extending from the base and between first and second portions of the base. The first portion of the base and one side of the leg would provide surfaces for window pane attachment. The second portion of the base being the outer peripheral attachment portion of the frame to facilitate attachment to the cab frame. While the frame can still be made of any materials, it is preferred that the frame with the transverse t-shape is made from an aluminum, e.g., a 6061 aluminum alloy, that is neither painted or coated. By using aluminum for the frame material, any adhesives used in connection with the window assembly adhere better to the aluminum frame and create a stronger bond between the window pane and frame.

The invention also includes a method of installing windows on the cab of off-highway material handling equipment designed for material handling to minimize window cracking. The method entails providing an off-highway equipment designed for material handling, the off-highway equipment including a cab with a cab frame and installing at least one window assembly according to the invention to portions of the cab frame, the at least one window assembly minimizing cracking of the window pane thereof by at least the second attaching means.

The off-highway equipment can be any type but is preferably a bulldozer. As part of the method, the cab frame can be equipped with at least one wiper blade assembly designed for contact with the at least one window assembly.

Another aspect of the invention is an improvement in moving coal in a coal surge pile, wherein the coal surge pile includes a conveyor at a bottom portion thereof. In this method, off-highway equipment that is designed for handling coal in the coal surge pile, the off-highway material handling equipment including a cab with a cab frame, and at least one window assembly according to the invention is attached to portions of the cab frame.

A further aspect of the invention is an improvement in off-highway equipment designed for material handling, the off-highway equipment including a cab and cab frame, and windows attached to the cab frame. The improvement is the use of at least one of the inventive window assemblies attached to portions of the cab frame. Preferably, the equipment is a bulldozing type. While one window assembly could be used in the equipment, preferably, a plurality of window assemblies are attached to portions of the cab frame.

### BRIEF DESCRIPTION OF THE DRAWINGS

FIG. 1 shows an example of a window pane for use in the inventive window assembly.

FIG. 2A shows an example of a frame designed to be attached to the window pane of FIG. 1, the frame then configured for attachment to a cab frame of a cab of a piece of off-highway material handling equipment.

FIG. 2B shows a section of an alternative to the frame design of FIG. 2A.

FIG. 3 shows a sectional view along the line III-III of the frame of FIG. 2A, with the window pane 1 of FIG. 1 attached to the frame of FIG. 2A.

FIG. 4 shows the view of FIG. 3 in an attached state, including a frame portion of the cab of a piece of off-highway equipment.

FIG. 5 shows a schematic representation of the inventive frame assembly installed on a piece of off-highway equipment.

FIG. 6 shows an alternative frame configuration.

FIG. 7 shows a t-bar member that can be used for frame construction.

FIG. 8 shows an exemplary frame made from t-bars like that of FIG. 7.

FIG. 9 shows a transverse cross section of a section of the frame of FIG. 7 with a window pane adhesively attached to the frame.

### DETAILED DESCRIPTION OF THE INVENTION

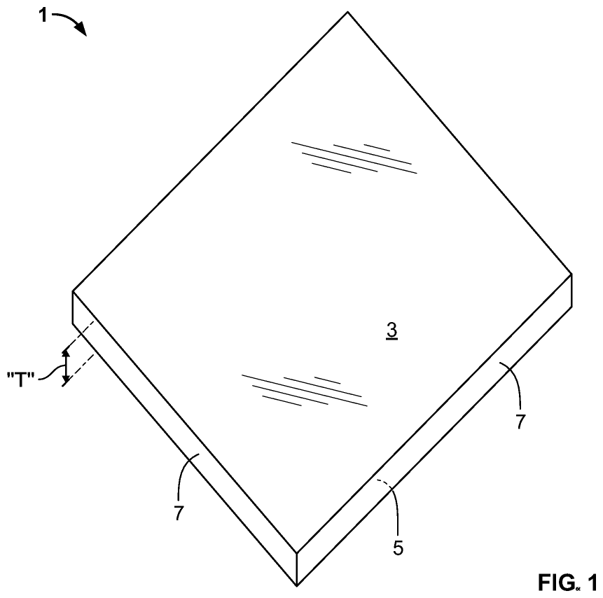

FIGS. 1-4 show features and one example of the inventive window assembly for use in off-highway material handling equipment. The window assembly is designated by the reference numeral 10 in the drawings.

FIG. 1 shows an example of a window pane 1, having opposing side surfaces 3 and 5 and peripheral end faces 7. The window pane is cut to size to match an opening in the cab of equipment that is to employ the inventive window assembly. The thickness of the window pane is designated by “T1” and preferably 1¼ inches thick but other thicknesses can be used as detailed below.

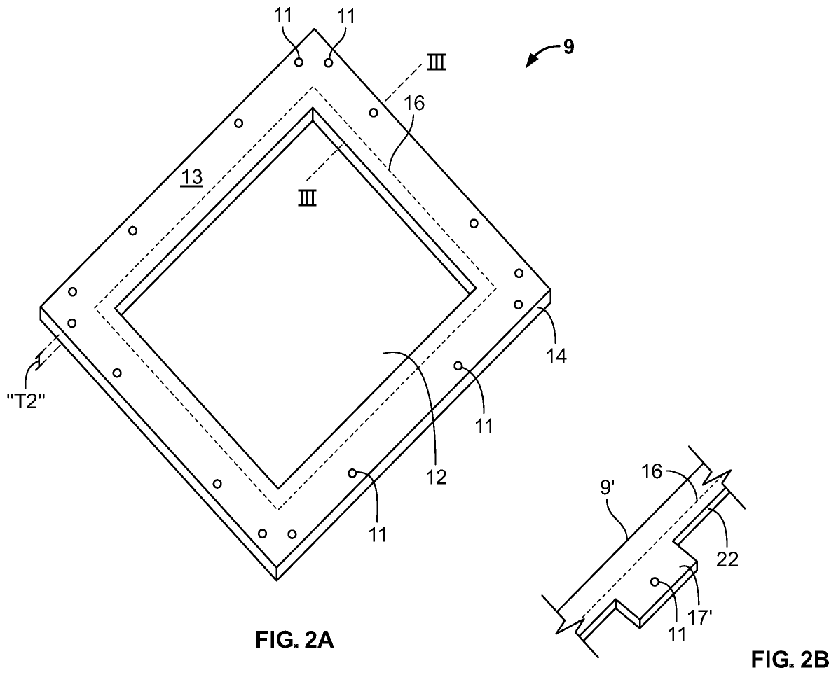

FIG. 2A shows an example of a frame 9, which is designed to interface with the window pane 1 to create the window assembly 10. The frame 9 includes an opening 12 so that the vision through the window pane is not obscured by portions of the frame. In this embodiment, the frame is plate-like in shape, with a thickness designated by “T2”, with a preferred thickness being about 3/16 inches, although other thicknesses can be employed as detailed below. While the frame can be made in any way, one way is to use four frame pieces and weld them together to form the frame 9. The frame 9 is preferably powder coated as is known in the art to deter corrosion once the window assembly 10 is mounted to the piece of off-highway material handling equipment.

The frame 9 also includes a plurality of pre-drilled openings 11, which function to facilitate attachment of the frame 9 to the cab of a piece of equipment as described in more detail below.

The frame 9 also includes a first surface 13, which is designed to face an outer peripheral portion of the surface 5 of the window pane of FIG. 1, and an outer peripheral face 14.

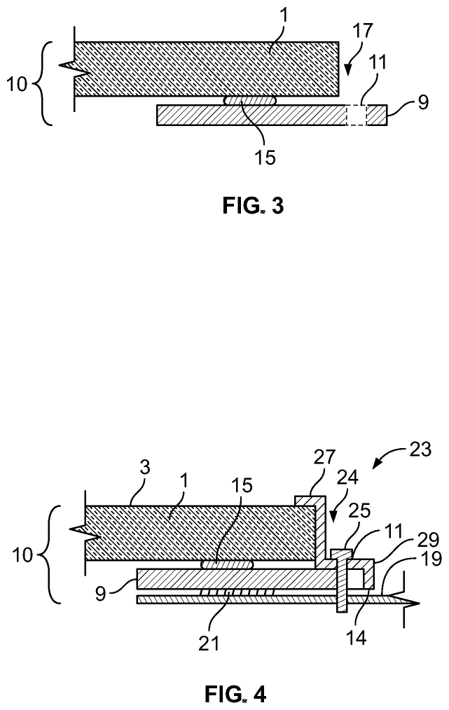

FIG. 3 shows a cross sectional view of a portion of the frame 9 and the window pane in an attached configuration to form the window assembly 10. One mode for attaching the window pane 1 to the frame 9 includes the use of an adhesive in the form of a rope, which is designated by the reference numeral 15. This adhesive is sold as a Window-Weld™ Ribbon and made by 3M. An exemplary diameter is ¼ inch. The adhesive is placed along the dashed line 16 shown in FIG. 2A. Once the adhesive rope 15 is in place on the dashed line 16, the window pane is positioned atop the surface 13 and the rope 15 and pressed against the surface 13 and rope 15 to adhere the window pane 1 to the frame 9.

In one embodiment, the frame 9 is sized to be larger than the window frame so that an entire outer periphery of the frame 9 that contains the openings 11 is not covered by the window pane 1. FIG. 3 shows the frame 9 and window pane 1 assembled along the line III-III of FIG. 2A. The rope 15 is shown in a compressed form as a result of pressing of the window pane 1 on the frame surface 13. FIG. 3 also shows an exposed outer periphery frame portion 17 of the frame surface 13 that facilitates securing the frame 9 to the cab of a piece of off-highway equipment. With the size of the frame 9 being larger than the size of the window pane 1, the frame portion 17 and through holes 11 can be employed with a fastening means to secure the frame 9 to the cab of a piece of off-highway material handling equipment. In this way, the window pane 1 is indirectly attached to the frame 9. With this indirect attachment, there is no need to drill openings in the window pane for fasteners and risk the occurrence of cracking of the window pane due to the fastener-window pane contact and window pane-cab contact as was the problem in the prior art designs for attaching windows to the cab of a piece of off-highway material handling equipment.

While the embodiment of FIG. 2A shows a frame, wherein an entire outer peripheral attachment portion is exposed to facilitate attachment of the frame to the cab of an off-highway piece of equipment, the frame periphery could be configured to that there are spaced apart outer peripheral attachment portions that allow for the frame attachment to the cab of off-highway equipment. These spaced apart portions would be more like flanges extending from the frame, the flanges forming the frame portion for attachment. FIG. 2B shows a section of such a frame 9′. In this embodiment, a frame portion 17′, as a flange, would extend from the frame peripheral face 22 and the window pane face 7 would generally align with the frame peripheral face 22.

FIG. 4 illustrates an exemplary mode of attachment of the window assembly, which comprises the frame 9, the adhesive 15, and window pane 1, to the cab of a piece of off-highway material handling equipment. This mode of attachment uses the view of FIG. 3 in combination with a portion of the frame of a cab of the piece of off-highway material handling equipment.

Once the frame 9 of the proper size is made to replace the existing window of a cab of the piece of off-highway equipment and the window pane is cut to size to fit with the frame as described above, the window assembly 10 is positioned on the frame of the cab. A portion of the frame of the cab is designated by the reference numeral 19. To maintain a seal between the cab frame portion 19 and the window assembly 10, a sealing material 21, e.g., a caulk or the like, can be positioned between the underside of the frame 9 and an outer surface of the cab frame portion 19. The sealing material provides a water proofing so that rain, dust, or other environmental components do not get into the cab.

Still referring to FIG. 4, an exemplary bracket designated by the reference number 23 is provided with a fastener 25, e.g., a self-tapping screw, to secure the window assembly 10 to the cab frame portion 19. The bracket 23 has an I-shaped portion 24, one leg facing the face 7 of the window pane 1 and the other leg facing the frame portion 17. The bracket can also include an upper flange 27 that contacts the surface 3 of the window pane 1 and a lower flange 29 that rests against the outer peripheral face 14 of the frame 9. The two flanges 27 and 29 provide additional support for keeping the window assembly 10 in place but are optional as detailed below.

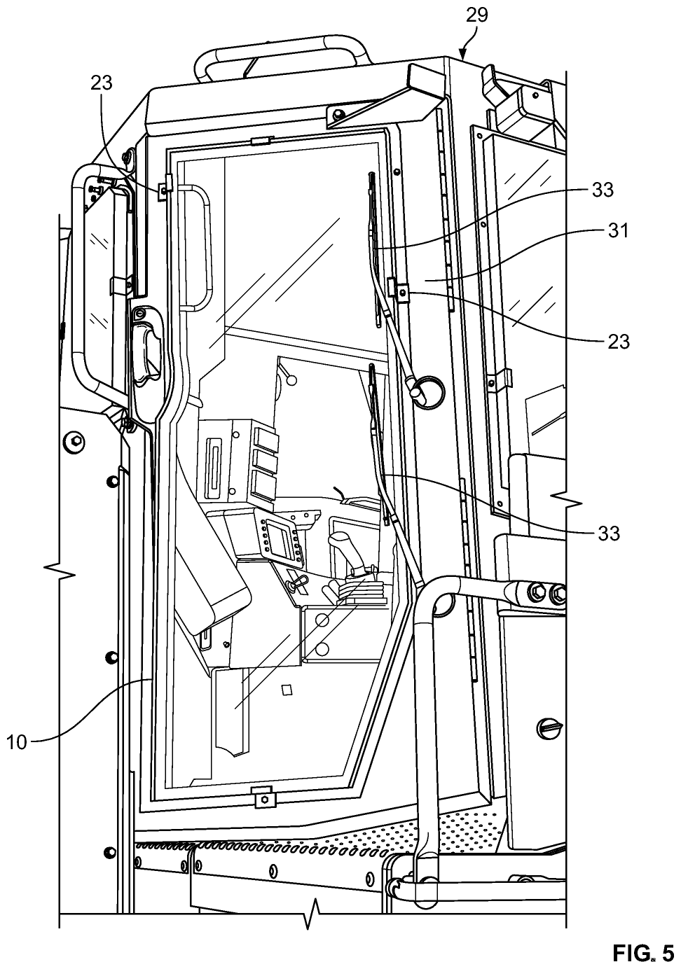

FIG. 5 shows the inventive window assembly in place on the cab of a piece of off-highway equipment in a schematic fashion. While the equipment is not fully shown, it is a Caterpillar brand bulldozer. In FIG. 5, the cab is designated by the reference numeral 30 and the frame portion that receives the window assembly is designated by the reference numeral 31. Also, shown are wiper mechanisms 33. A number of the brackets 23 can be seen securing the top, bottom, and side portions of the window pane 10 to the cab 29. It can also be seen that the frame 9 and window pane 1 have a special cut rather than the one shown in FIGS. 1 and 2A as the window assembly in FIG. 5 is used as part of the door of the cab 29.

It should be understood that the pre-drilled holes 11, exposed frame portion 17, bracket 23, and fastener 25 are all considered as one example of a means for indirectly attaching the window assembly 10 to the cab 29 of the piece of off-highway equipment. A different configuration of bracket or window assembly holding member, e.g., one that is purely I-shaped rather than a flange-containing one, could be used. Also, different kinds of fasteners could be used providing that the frame 9 is attached to the cab rather than involving the window pane 1. Any means that attaches the frame 9 to the cab frame while avoiding the need for the window pane to be in contact with the frame of the cab can be employed as part of the invention.

Similarly, the use of the adhesive rope 15 is one example of a means for fastening the window pane 1 to the frame 9 so that the frame is the component that is attached to the cab rather than the window pane 1 itself.

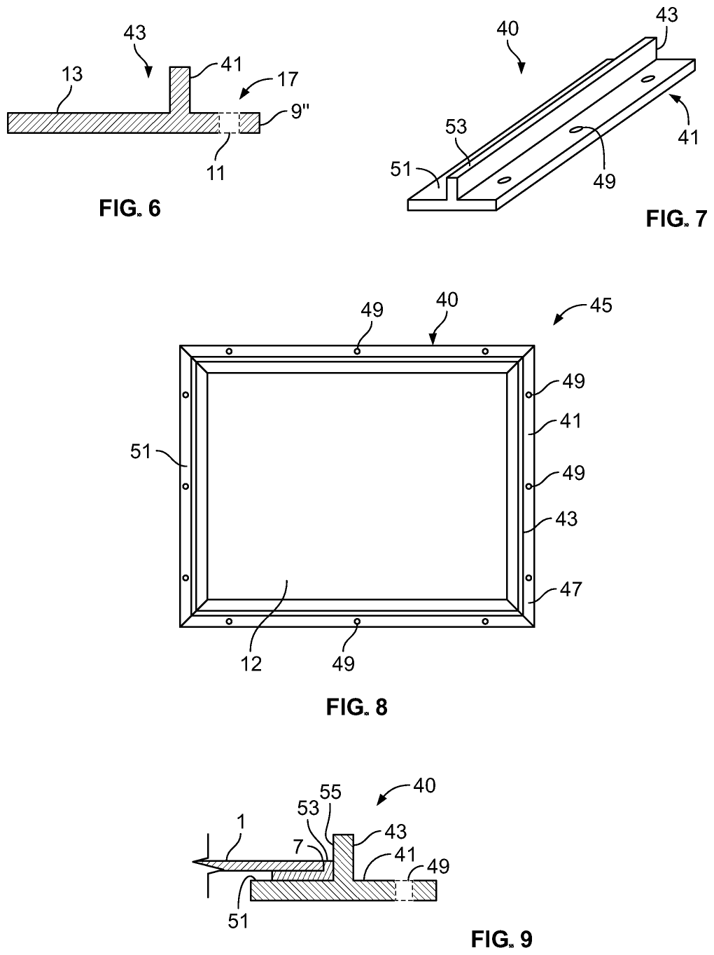

In another embodiment, the frame 9 could include a flange that would form a cavity for the window pane to rest in as seen in FIG. 6 and a frame 9″ is shown with a flange 41 extending from the frame surface 13′. This embodiment still employs the frame portion 17 and through hole 11 to facilitate attachment of the frame 9″ to the cab. With the flange 41 extending around the surface 13 of the frame, a recess 43 is formed along an inner portion of the frame 9″ to receive and retain the window pane 1 when placed on the frame 9″. This embodiment provides an advantage of more securely holding the window pane 1 in place. However, the frame embodiment of FIG. 2A has its advantages as well in that the cut of the window pane does not have to be as precise as there is no recess 43 or flange 41 to contend with. Also, the frame 9 of FIG. 2A can be made of bar stock and is more economically made.

Expanding on the use of the frame of FIG. 6 as an alternative to a flat frame as shown in FIG. 1, the flange 41 can be effectively provided by the use of t-bars, such as the ones available as part no. 1668T3 in the McMaster-Carr Catalog.

A t-bar is designated by the reference numeral 40 in FIG. 7, having the top of the tee designated by 51 and the leg of the tee designated by 53. FIG. 8 shows an example of a frame 45 made using the t-bar 40 of FIG. 7, the frame forming the opening 12. In contrast to the use of plate pieces, wherein the plate pieces do not have to be welded together on the bias, the frame 45 uses mitered corners so that the tee legs 53 join at the corners to form a frame enclosure for the window pane 1.

Consistent with FIG. 6, one side 47 of the tee top 51 is used as the outer peripheral portion of the frame for attachment to the frame of the cab. The means for attachment of the side 47 can be openings 49, that allow fasteners to pass therethrough for attachment to the cab frame. Consistent with the description of FIG. 6, using the t-bar provides two surfaces, one being on one side of the tee leg 53 and the other being a surface of the other side of the tee top 51 for adhesive application and securing the window pane 1 to the surfaces of the t-bar 40.

FIG. 9 shows a transverse cross sectional view of a part of the frame 45 of FIG. 8 with a window pane attached thereto. An adhesive 61 is positioned between an outer peripheral portion of the window pane 1 and a side of the t-bar 40 opposite to the side 47. Given the t-bar configuration of the frame transverse cross section, the adhesive 61 can also be between the end face 7 of the window pane 1 and the side 55 of the leg 53. Although not shown, a fastener could be employed to secure the frame 45 to the cab frame using the opening 49.

Another advantage of using a stock t-bar is the use of an aluminum as the t-bar material. The t-bar supplied from McMasters-Carr is a 6061 bare surface aluminum alloy. For certain adhesives used in connection with an embodiment of the invention that uses powder coated frame materials, the adhesives can dislodge the powder coating from the frame material, thus causing an unsightly look in terms of the frame and window pane when mounted to a cab frame. Dislodging the powder coating can also be a disposal and/or environmental concern as the powder coating would be freely dispersed into the environment. Using an aluminum t-bar frame material avoids the problem of powder coating degradation while still providing the necessary strength for holding the window pane in place and attachment to a cab frame. The use of a t-bar material also provides the advantage of adhesive attachment along an outer perimeter face of the window pane and along the side edge of the window pane, thus improving the attachment of the window pane to the frame 45. Use of the t-bar also provides a built in means for attaching the frame to a cab frame as the side 57 of the tee top 51 41, thus eliminating the need for a separate bracket as shown in FIG. 4. Of course, a bracket like that shown in FIG. 4 could still be employed with the t-bar embodiment of FIGS. 7 and 8, just that the bracket upper flange would be lengthened to extend over the end face of the tee leg 53 in order to cover a portion of the window pane for extra securement.

When a need exists to replace the window pane 1, the replacement is easily done. In one way, the fasteners 25 can be removed so that the frame 9 can be detached from the frame portion 19 of the cab 29. Once the frame 9 is removed, a cutting device like a saw can be used to cut through the seal material 15 so to break the connection between the window pane 1 and frame 9. Once the seal is broken, the window pane 1 can be removed and the frame 9 cleaned of residual adhesive. A new window pane would then be attached to the frame using a new sealing material. The completed window assembly can then be attached to the cab as described above.

The inventive window assembly could also be used in manufacturing a new piece of off-highway material handling equipment. In this mode, there is no window assembly to be removed and the inventive window assembly is attached to the cab frame as detailed above.

It should be understood that the term off-highway equipment encompasses any kind of equipment that is only designed for off-highway use. Examples of these kinds of equipment are bulldozers typically used in a coal mining operation. However, other equipment, wherein the safety of the operator requires high strength windows in a cab of the equipment, are candidates for the window assembly of the invention, e.g., grader, shovels, scrapers, and the like.

The frame of the window assembly is preferably made from steel with a thickness of at least 3/16 inches and up to about a half inch thick material. While increased thickness of the frame can be employed, no great advantage is seen as the exemplified thickness and use of steel material provide sufficient strength for the frame integrity.

The window assembly frame thickness is preferably greater than the thickness of the frame material used to make the cab of the equipment as is shown in FIG. 4, i.e., ¼ thickness for the cab frame material. By having a greater thickness for the frame 9, the frame 9 is more resistant to the vibration and flexing due to the equipment operating. With the vibrations dampened and flexing decreased, there is less chance for any damage to be done to one or more of the window assemblies after installation. The frame thickness is also preferably in the 3/16 inch range as using thicker materials increases costs and adds unnecessary weight to the assembly.

The shape of the frame 9 and configuration of the flanges is based on the particular configuration of the cab of the off-highway equipment to be fitted with the inventive window assemblies. For example, Caterpillar D9-D11 type dozers are commonly used in coal mining operations and the window pane 1 and frame 9 would be designed to be used with the cabs of these kinds of dozers. Other dozers or other material handling off-highway equipment would require shapes of window panes 1 and frames 9 that conform to their cab configurations.

While an acrylic material is a preferred choice of materials for the window of the inventive window assembly, other polymeric material can be employed that would meet glass strengths needed by law and/or regulation and the like and would be sufficiently hard enough that they would not be easily scratched when mounted to the cab of a piece of equipment. A typical hardness for an acrylic is M95 on the Rockwell M scale so other materials with comparable hardnesses could be used for the window pane.

While the preferred thickness of the acrylic material window is about 1¼ inches, other thicknesses could be employed as would be within the skill of the art, e.g. up to 1¾ inches and down to around an inch or so. With a change in thickness goes a change in the configuration of the frame to accommodate the thickness of the window if the frame should be other than the flat bar stock used in making the frame of FIG. 2A.

It should also be understood that when mounting the new window assembly, the window pane thickness may be such that extensions would be need for the wiper assemblies shown in FIG. 5. Since a prior art window thickness is typically ⅝ inch, increasing the window thickness to 1¼ inches would require the wiper assemblies to be extended from the cab to accommodate the increase window pane thickness. Any known spacing means or techniques could be used to relocate the wiper assemblies so that they can perform the intended wiping function. Given that at least certain windows employ one or more wiper assemblies in off-highway material handling equipment, the window pane thickness should not be too thick so as to create problems when accounting for the need to have wiper assemblies with wiper blades that must contact the window pane surfaces.

The invention also entails a method of installing one or more window assemblies on an off-highway piece of equipment to prevent window cracking during operation of the equipment, the equipment preferably involved in coal handling that is in need for cab protection in the event of a coal surge pile collapse. In this method, one or more of the window assemblies described above is installed on the frame of the cab of the off-highway equipment using the means for fastening the window assembly to the cab frame. A preferred piece of off-highway equipment is a bulldozer, including those kinds that employ wiper blades on one or more of the windows of the cab. With the window assembly installed, wherein the window pane is indirectly attached to the cab frame, the chances of the window pane cracking due to vibration and flexing due to operation of the equipment is vastly reduced, if not completely eliminated.

Another aspect of the invention is an improvement in moving coal in a surge pile using an off-highway piece of equipment like a bulldozer. In this improvement, the off-highway piece of equipment is equipped with one or more of the inventive window assemblies attached to the equipment cab. With the inventive window assemblies in place on the cab of the equipment, equipment down time due to window replacement and the monetary effect associated therewith is significantly reduced as the window panes do not having the cracking that is prevalent in equipment using the prior art style of window panes, and the coal moving operation is significantly improved.

Yet another aspect of the invention is the improvement in an off-highway piece of equipment designed for material handling, the off-highway equipment including a cab and cab frame, and windows attached to the cab frame. The off-highway equipment is provided with at least one window assembly according invention, the window assembly attached to portions of the cab frame as detailed above.

The inventive window assembly provides significant advantages in the field of off-highway equipment that requires window that are strong enough to prevent window failure if the off-highway equipment happens to be in a condition where excessive weight and/or forces would be applied against the window. While prior art windows can accomplish this function, they do so in a problematic manner as the windows can crack and need frequent replacement, such replacement causing significant downtime for the equipment operation. With the inventive window assembly, window cracking is alleviated as the inventive window assembly separates the window pane from direct attachment to the off-highway equipment, while at the same time, providing an efficient way for window installation and/or replacement that minimizes the downtime for the off-highway equipment.

As such, an invention has been disclosed in terms of preferred embodiments thereof which fulfills each and every one of the objects of the present invention as set forth above and provides a new and improved window assembly for use in an off-highway equipment designed for material handling, a method of installing the window assemblies on the equipment, a method of use of the equipment with the window assemblies installed for material handling, and the equipment with the window assemblies as a part thereof.

Of course, various changes, modifications and alterations from the teachings of the present invention may be contemplated by those skilled in the art without departing from the intended spirit and scope thereof. It is intended that the present invention only be limited by the terms of the appended claims.

I claim:

1. A window assembly for use in off-highway equipment designed for material handling, the off-highway equipment having a cab with a cab frame and windows, the window assembly comprising:
a frame having an opening therein and an outer peripheral attachment portion,
a window pane made from a polymeric material and having first and second surfaces and an outer peripheral face, the first surface having an outer peripheral portion;
first means for attaching the outer peripheral portion of the first surface of the window pane to a portion of the frame so as to leave the outer peripheral attachment portion exposed; and
second means for attaching the outer peripheral attachment portion of the metal frame to a cab frame, the means independent of the window pane so that the window pane does not develop cracks by direct attachment of the window pane to the cab frame.

2. The window assembly of claim 1, wherein the polymeric material is an acrylic material and/or the frame is metal.

3. The window assembly of claim 1, wherein the first attaching means comprises an adhesive positioned between a surface of the frame adjacent to the outer peripheral attachment portion of the frame and the outer peripheral portion of the window pane.

4. The window assembly of claim 1, wherein the second means includes a bracket configured to contact the outer peripheral attachment portion of the frame and having an opening therethrough, at least one through hole in the outer peripheral attachment portion, and at least one fastener adapted to retain the bracket and the outer peripheral attachment portion of the frame to the cab frame by extending through the opening in the bracket and through hole in the outer peripheral attachment portion of the frame.

5. The window assembly of claim 2, wherein the second means includes a bracket configured to contact the outer peripheral attachment portion of the frame and having an opening therethrough, at least one through hole in the outer peripheral attachment portion, and at least one fastener adapted to retain the bracket and the outer peripheral attachment portion of the frame to the cab frame by extending through the opening in the bracket and through hole in the outer peripheral attachment portion of the frame.

6. The window assembly of claim 1, wherein the frame has a t-shape in transverse cross section, the frame further comprising a base with a leg extending from the base and between first and second portions of the base, the first portion of the base and one side of the leg forming the portion of the frame for window pane attachment, the second portion of the base being the outer peripheral attachment portion of the frame to attachment to the cab frame.

7. The window assembly of claim 6, wherein the frame is made from an aluminum alloy.

8. A method of installing windows on the cab of off-highway equipment designed for material handling to minimize window cracking comprising:
a) providing an off-highway equipment designed for material handling, the off-highway equipment including a cab with a cab frame; and
b) installing at least one window assembly according to claim 1 to portions of the cab frame, the at least one window assembly minimizing cracking of the window pane thereof by at least the second attaching means.

9. The method of claim 8, wherein the off-highway equipment is a bulldozer.

10. The method of claim 8, wherein the cab frame is equipped with at least one wiper blade assembly designed for contact with the at least one window assembly.

11. A method of moving coal in a coal surge pile, wherein the coal surge pile includes a conveyor at a bottom portion thereof, the method comprising:
providing an off-highway equipment designed for handling coal in the coal surge pile, the off-highway equipment including a cab with a cab frame, and at least one window assembly according to claim 1 attached to portions of the cab frame; and
moving coal with the off-highway equipment.

12. The method of claim 11, wherein the off-highway equipment is a bulldozer.

13. In an off-highway equipment designed for material handling, the off-highway equipment including a cab and cab frame, and windows attached to the cab frame, the improvement comprising at least one window assembly according to claim 1 attached to portions of the cab frame.

14. The equipment of claim 13, wherein the off-highway equipment is a bulldozer.

15. The equipment of claim 13, wherein a plurality of window assemblies are attached to portions of the cab frame.

16. The equipment of claim 13, wherein the cab frame is equipped with at least one wiper blade assembly designed for contact with the at least one window assembly.

17. The window assembly of claim 7, wherein the aluminum alloy is unpainted or uncoated.
